(19) United States
(12) Patent Application Publication
(10) Pub. No.: US 2009/0198532 A1
(43) Pub. Date: Aug. 6, 2009

(54) METHOD AND TOOL FOR BUSINESS PROCESS ADAPTATION USING GOAL MODELING AND ANALYSIS

(75) Inventors: Marin Litoiu, Toronto (CA); Karl Pierre Weckworth, East York (CA); Alexei Lapouchnian, Toronto (CA)

Correspondence Address: AKERMAN SENTERFITT, P.O. BOX 3188, WEST PALM BEACH, FL, 33402-3188, US

(73) Assignee: INTERNATIONAL BUSINESS MACHINES CORPORATION, Armonk, NY (US)

(21) Appl. No.: 12/023,708

(22) Filed: Jan. 31, 2008

(51) Int. Cl. G06Q 10/00

(52) U.S. Cl. 705/7

(57) ABSTRACT

A business process (BP) adaptation system (400) includes a High-Variability enriched Goal Model (HVGM) (402) that captures and refines goals of a business process (BP) while modeling alternative options where the model captures non-functional or quality attributes used in an evaluation of a performance of the BP and an estimation of how various BP alternatives affect the quality attributes. The system further includes a High-Variability workflow-level/directly Executable Model (HVEM) (404), where the system is based on goal modeling and analysis for eliciting intentions behind a BP to achieve a desired goal and the HVGM explicitly models non-functional or quality concerns. The system can further include a semi-automatic generator (604) of BP metrics based on the quality attributes specified in the HVGM and a runtime infrastructure (610) where each deployed BP instance reflects a configuration selected for that instance in a corresponding portion of the HVGM.

### FIELD OF THE INVENTION

The present invention relates to the field of business models and, more particularly, to a method and system for business process adaptation using goal modeling and analysis.

### BACKGROUND

At present, process orientation is a dominant paradigm for businesses. There are many definitions of what a business process (BP) is, but in general a BP is seen as a collection of activities that achieves some business purpose or objective aiming to create value for customers. So, business processes specify ways to achieve business goals. Thus, it seems to be natural for business process modeling methods to include facilities for modeling these goals. Unfortunately, most popular BP modeling approaches such as Business Process Modeling Notation (BPMN) or Event-Driven Process Chains (EPCs) are workflow-level notations. They capture processes at a workflow level, in terms of activities, flows, and so forth. However, these notations do not allow the analysis of process alternatives in terms of high-level quality attributes or business goals and thus do not provide traceability of BP alternatives to requirements.

Business processes defined at the workflow level specify the sequence of tasks that are to be carried out by various roles within an organization and/or by various automated systems to deliver a service/product to a customer. In general, workflow-level process specifications do not capture the intentions behind business activities. Thus, it is difficult to understand why a BP is defined as it is and what a certain modification can do to the process itself and to its quality characteristics.

There are, nevertheless, BP modeling approaches that explicitly capture and refine business goals. These approaches do not model quality characteristics of processes explicitly. Similarly, they do not model process variations (process variability) and how they affect the important quality attributes of the processes.

Due to the need to accommodate changing business priorities as well as business cases with varying characteristics (for example, customers with different preferences), business process specifications need to be flexible as well as capable of being configured and reconfigured appropriately. Currently, techniques as diverse as business rules and late modeling are used for changing workflow-based BPs.

Most techniques for manual BP adaptation require the extensive knowledge of the process and, possibly, the modeling notation to be effectively applied thus making it difficult for non-technical users to configure or adapt BPs. In terms of automatic BP reconfiguration, certain automations are currently included in workflow management systems. These include, for example, the automated escalation and/or reassignment of unclaimed or unfinished tasks.

However, these approaches and techniques are quite low-level and the possible configurations are not explicitly evaluated with respect to business goals and priorities. Thus, it is hard to select process alternatives with desired non-functional characteristics or request a modification of a business process to automatically improve certain process characteristics. The rationale behind reconfiguration possibilities (e.g., in a business rule) is not usually documented.

Most current BP modeling notations do not emphasize the modeling of business process variability. Rather, they eliminate the alternatives/configurations that are deemed infeasible, and instead concentrate on a single chosen alternative. This leads to business processes that may be optimal at the deployment time, but which are very difficult to reconfigure/adapt in case of changing business environment or process execution failures. Some of the discarded alternatives may now become the optimal configurations or otherwise viable alternatives. Nevertheless, none of the approaches in BP management currently allow a systematic modeling of process alternatives and their characteristics.

While some research has focused on certain limited aspects of variability in business process models, the proposed solutions are not easily accessible to non-technical people. Similarly, research on configurable BPEL processes so far mostly concentrated on low-level configurability that may not be visible to process users.

### SUMMARY

An approach for a requirements-driven design of autonomic software systems as contemplated herein emphasizes the elicitation of goals behind software systems and the modeling of (usually user-visible) alternative ways for achieving those goals. The modeling approach presented in the embodiments herein address several problems including the problem of automatic or semi-automatic adaptation of business processes based on the changes in business requirements and/or the data collected from deployed business processes.

In one embodiment, a business process (BP) adaptation system can include a High-Variability enriched Goal Model (HVGM) that captures and refines goals of a business process while modeling alternative options in which goals can be attained, where the model captures non-functional or quality attributes used in an evaluation of a performance of the business process and an estimation of how various BP alternatives affect the quality attributes, and a High-Variability workflow-level/directly Executable Model (HVEM) of the business process, which is semi-automatically generated from the HVGM.

In another embodiment, a business process (BP) adaptation system can include a High-Variability enriched Goal Model (HVGM) that captures and refines goals of a business process while modeling alternative options in which goals can be attained where the model captures non-functional or quality attributes used in an evaluation of a performance of the business process and an estimation of how various BP alternatives affect the quality attributes. The system can further include a High-Variability workflow-level/directly Executable Model (HVEM) of the business process, which is semi-automatically generated from the HVGM where the system is based on goal modeling and analysis for eliciting intentions behind a business process to achieve a desired goal, and the HVGM explicitly models non-functional or quality concerns. The system can further include a semi-automatic generator of business process metrics based on the quality attributes specified in the HVGM and a runtime infrastructure, where each deployed BP instance reflects a configuration selected for that instance in a corresponding portion of the HVGM. The runtime infrastructure can further include an external monitoring tool for monitoring and analyzing information collected at runtime to enable automated reconfiguration of a deployed HVEM to improve performance in terms of a desired satisfaction level of quality attributes and their relative priorities or to recover from failures by selecting alternative configuration in the set of BP configurations modeled in the HVGM and implemented in HVEM.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is an illustration of a HVGM for a supply customer BP in accordance with an embodiment of the present invention.

FIG. 2 illustrates the process of selecting and assessing alternative business processes in accordance with an embodiment of the present invention.

FIG. 3 illustrates a mapping of goal models into Business Process Execution Language in accordance with an embodiment of the present invention.

FIG. 4 illustrates a requirements-driven Business Process configuration in accordance with an embodiment of the present invention.

FIG. 5 is a block diagram of an autonomic element in accordance with an embodiment of the present invention.

FIG. 6 illustrates a runtime Business Process adaptation in accordance with an embodiment of the present invention.

### DETAILED DESCRIPTION

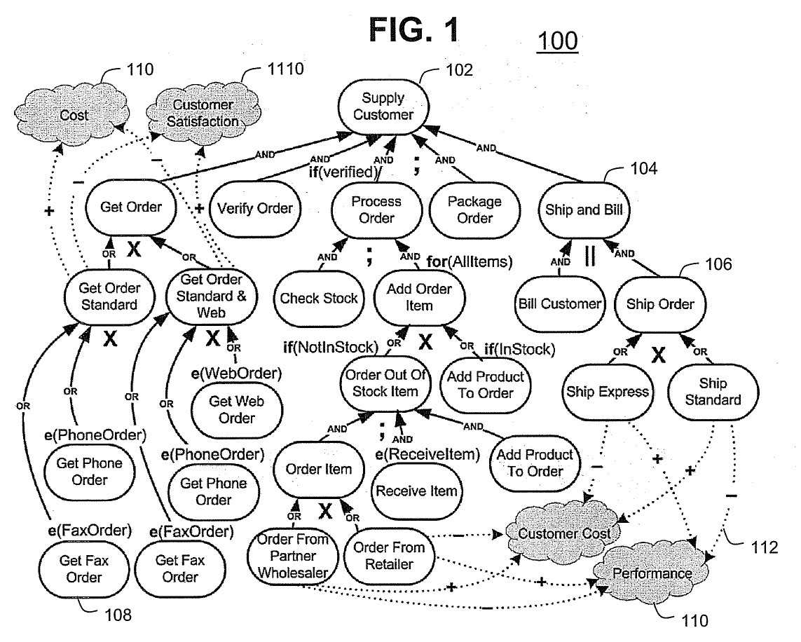

The embodiments as shown in FIGS. 1-6 address at least the problem of automatic or semi-automatic adaptation of business processes based on the changes in business requirements and/or the data collected from deployed business processes. Some of the components of a system or method in accordance with the arrangements herein can include a High-Variability enriched Goal Model (HVGM) that captures and refines the goals of a business process while modeling the alternative ways these goals can be attained. The model can also capture non-functional (or quality) attributes to be used in the evaluation of the performance of the process and an estimation of how various BP alternatives affect the quality attributes. The best BP alternative can be automatically found based on the prioritization and the desired satisfaction levels for the quality attributes of the BP. This prioritization can be done at a high level by business users. Such a system or method can further include a High-Variability workflow-level/directly Executable Model (HVEM) of the business process, which can be semi-automatically generated from the HVGM. The executable model implements a full set or a subset of alternatives specified in the corresponding HVGM. Thus, the HVEM can be configured to execute a particular available BP configuration. The preserved traceability between HVGM and HVEM allows this configuration of the HVEM to be done based on the currently-chosen alternative in the corresponding HVGM. In terms of the BP configuration, this allows non-technical business users to configure deployed BPs by manipulating quality attributes such as “[modify, decrease, or increase] Customer Satisfaction” or “Minimize Process Cost,” or other quality attribute. The system or method can further include a means for semi-automatic generation of business process metrics based on the quality attributes specified in the HVGM.

Additionally, a system or method as contemplated herein can further include a runtime infrastructure where each deployed BP instance reflects the configuration selected for that instance in the corresponding HVGM. The infrastructure allows for functions such as configuring the deployed HVEM based on the selected configuration in the corresponding HVGM. The configuration can be specified in terms of desired satisfaction levels of quality attributes and their relative priorities. Analysis of the deployed BP instances can be based on the monitoring information collected at runtime by an external monitoring tool (for example, by IBM's WebSphere Business Monitor) which can further enable automated reconfiguration of the deployed HVEM to improve the model's performance (in terms of improving the positive contribution to the quality attributes of the process) or to recover from failures by selecting alternative configurations in the set of process configurations modeled in the HVGM and implemented in HVEM. The selection of the new BP configuration out of a finite set of predefined BP configurations is done at the intentional level, in terms of business goals and high-level quality attributes. “Intentional level” in this context can mean attempting to understand what a human is trying to do in an attempt to emulate a task to achieve an intended goal without necessarily matching the steps a human would actually tale.

Among the advantages of such a modeling approach include the ability to develop BP models from the intentional perspective in terms of the business goals they achieve. Such arrangement also allows for a systematic specification and analysis of alternative ways of achieving the identified business goals. Non-functional (quality) requirements can also be explicitly represented and analyzed. Such models also allow for a semi-automatic generation of workflow-level executable high-variability BPs. Further note that the HVEMs can be configured or based on the HVGMs since the traceability between the higher-level intentional model of a BP (HVGM) and the deployed HVEM is preserved. This characteristic also allows non-technical users to configure deployed BPs. HVGMs can also be used to present the space of BP alternatives and the currently selected alternative to business stakeholders in high-level terms. The automated tuning, healing and configuration of deployed BPs can be done (albeit within the scope of the deployed alternatives) by non-technical user (and technical users alike).

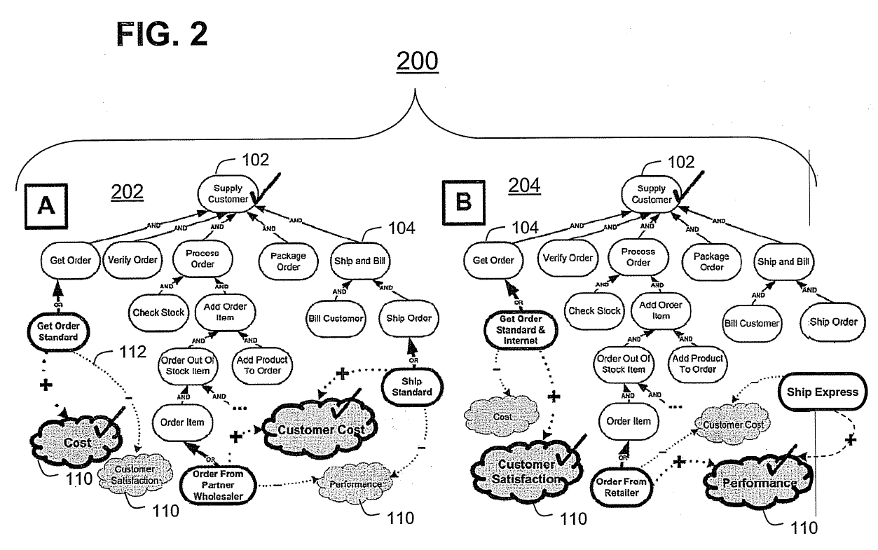

Referring to FIG. 1, a high-variability goal model 100 is depicted. The approach used for the design and adaptation of business processes is based in part on the ideas from Requirements Engineering, namely, goal modeling and analysis. Hence, the focus is on the elicitation of intentions behind a business process. For example, goal model 100 depicts a goal model for the process that might be executed by a wholesale distributor. The intentions are modeled as business goals 102, 104, 106, and 108 that are then further analyzed and refined using simple AND/OR refinements. In FIG. 2, the top-level goal 102 of the wholesaler is “Supply Customer” and the model 200 illustrates alternatives 202 and 204 that show how it can be refined. Additionally, the model places an emphasis on identifying and analyzing variability in the business domain in order to come up with a wealth of business process alternatives that all are achieving the identified business goals. Naturally, an OR goal decomposition is a way to model alternative ways of achieving a parent goal. These OR decompositions are referred to as variation points. The refinement of business goals can stop when the leaf-level goals in the model are simple enough to be delegated to human actors or software systems. As noted above, a feature of this modeling approach is the explicit modeling of non-functional (or quality) concerns related to business processes. These are modeled in the same goal models as business goals and are represented in those models by softgoals or softgoal nodes 110. In FIG. 1, softgoals 110 are (Minimize) Cost (for example, minimizing the cost of running the process), (Maximize) Customer Satisfaction, (Minimize) Customer Cost, and (Maximize) Performance of the process. Softgoals can also be refined where more abstract softgoals can be decomposed into lower level ones. Softgoals are a means to the analysis of the process alternatives. This is made possible through the use of qualitative or quantitative contribution links 112 that specify how a particular business goal affects a softgoal (either positively or negatively). For example, in the Supply Customer process, the goal Ship Express contributes positively to the softgoal Performance, while also contributing negatively to Customer Cost. Conflicting softgoals can be very common in the models contemplated herein.

The conflicts can be resolved based on setting the priorities of softgoals. Given the desired satisfaction levels for softgoals and the prioritization among them, an automated reasoning algorithm can determine the BP alternative(s) that are the best for achieving those satisfaction levels. Different stakeholders at different times may have different desired satisfaction levels for the quality concerns. For example, some customers may prefer faster deliveries (for example, the softgoal Performance can be given the highest priority), while others may choose to save money (where minimizing Customer Cost can be of the highest priority instead). The alternative configurations 202 or 204 of the alternatives 200 are shown in FIG. 2. The result of the modeling is a high-variability goal model (HVGM) representing the intentions or goals behind the process and ways that these goals can be accommodated in the business domain (the alternative refinements).

The Goal models as contemplated herein can also include additional enrichments. While goal models as described above can be used for the analysis of business process requirements, these models can also be used to semi-automatically generate workflow-level BP specifications. The model should capture more information than a basic goal model allows. Goal model annotations as shown in FIG. 1 are one way to increase the precision of the models. These annotations capture the details of the control flow. Parallel (“∥”) or sequence (“;”) annotations can be used with AND-decomposed goals to specify whether or not their sub-goals are to be achieved in a temporal order. For example, achieving the goal “Get Customer Order” must be achieved before “Process Order” (see FIG. 1). Note that this sequencing is not a design decision, but a feature of the problem domain. Similarly, such a model can support conditional and loop annotations as well as event annotations (modeling the arrival or an external or internal event). Additionally, arrangements herein also enable modeling the input and output parameters for goals. Identifying inputs and outputs during the analysis of a business domain helps in determining resource requirements for achieving goals as well as for the sequencing of the goals. The types of inputs and outputs can also be specified.

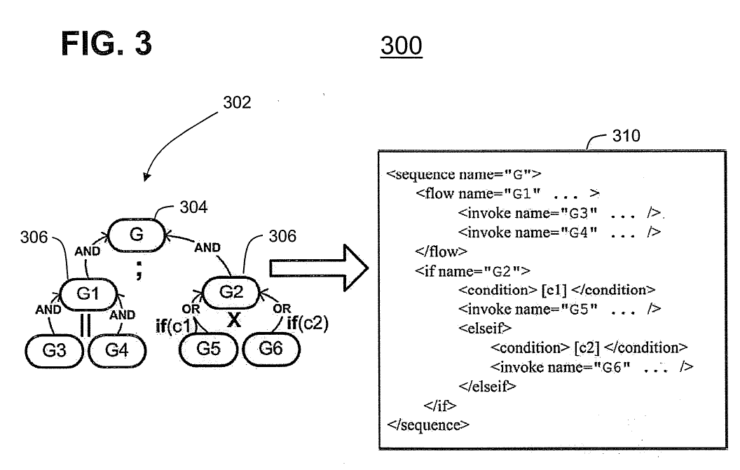

Referring to FIG. 3, a mapping 300 of goal models between HVGMs 302 and HVEMs 310 is illustrated. Once all of the above enrichments have been specified, the enriched high-variability goal model 300 can be semi-automatically mapped into a high-variability workflow-level specification (310) of a business process in, for example, Business Process Specification Language for Web Services 2.0 (WS-BPEL 2.0), the notation of the IBM WebSphere Business Modeler (WBM), or some other appropriate notation. The resultant model, as noted above, is referred to as a High-Variability Executable Model (HVEM) of a business process. The automated procedure maps leaf-level goals (304, 306, etc.) into tasks (WBM) or Web service invocations (BPEL) in the HVEM 310. Higher-level goals map to various control flow constructs depending on their annotations. For example, sequential AND-decomposed goals will be replaced by the sequential combination of the results of mapping of the sub-goals of the AND-decomposed goal. Other appropriate control flow constructs will be generated based on condition, loop and other annotations specified in the HVGM. More particularly, FIG. 3 is a sample mapping of a goal model fragment 302 into WS-BPEL 2.0.

Further note, special consideration is given to the mapping of variation points. These are the main configuration points for the business process. In the embodiments, a HVEM can be automatically configured based on the configuration of a corresponding HVGM. Thus, HVEMs can be specified in a way that allows them to get the appropriate configuration from a runtime infrastructure.

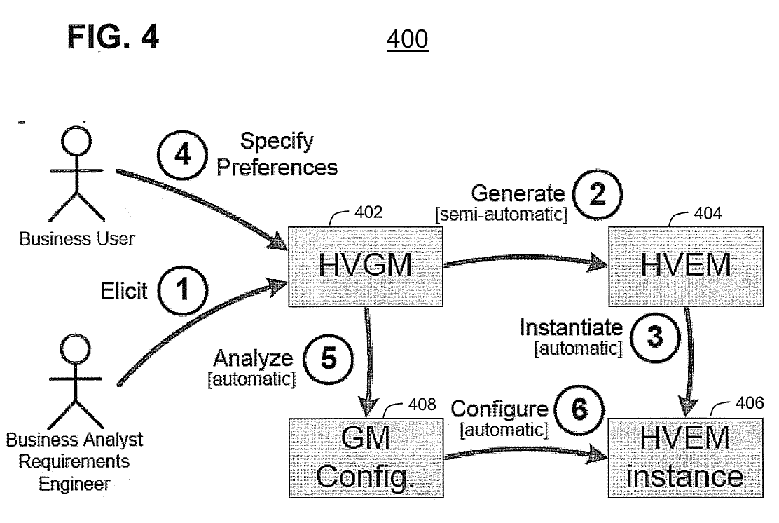

Referring to FIG. 4, a requirements-driven BP configuration 400 as illustrated presents an overview of the steps of an approach for a requirements-driven and preferences-driven configuration of business processes, without a feedback loop. First (1), a high-variability goal model (HGVM) 402 is elicited which can typically be done by a business analyst or a requirements engineer for example. Second (2), the HVGM 402 is then used to generate a worlflow-level high-variability executable model (HVEM) 404 of a business process, which is deployed and instantiated (3) as an HVEM instance 406. Next (4), stakeholder preferences are provided to the automated goal reasoning algorithm of the HVGM 402, which produces (5) the intentional (in terms of business goals) process configuration 408 that best suits these preferences. The corresponding configuration of the executable process is created (6) based on the goal model configuration 408.

With respect to specifications for business measures, goal models can be used to help in the specification of business measures models that are used to analyze the performance of business processes. Softgoals that represent important quality requirements for business processes capture at a high level the metrics that are used to analyze or compare various BP alternatives specified in HVGMs. They play a role not unlike business measures or Key Performance Indicators (KPIs) in traditional business process management. However, softgoals in basic goal models do not correspond to any monitored and measurable quantities. Rather, they are imprecise and subjective. The embodiments herein can use softgoals as a starting point for the development of a precise or quantitative business measures model. In order to do that, softgoals need to be metricized (refined into measurable metrics). In some domains, such metrics are well-defined and well-accepted. For example, a popular metric for reliability (a high-level quality attribute) is the mean time between failures.

In general, domain-independent quality attributes such as cost, time, and others can be easily mapped into low-level metrics that existing monitoring tools such as the WebSphere Business Monitor can capture. However, certain other softgoals are much more difficult to metricize. Overall, however, KPIs can be derived from important softgoals by metricizing these softgoals and by providing the desired value or range for the obtained metric. At this stage, some of the qualitative contribution links in goal models can be replaced with expressions.

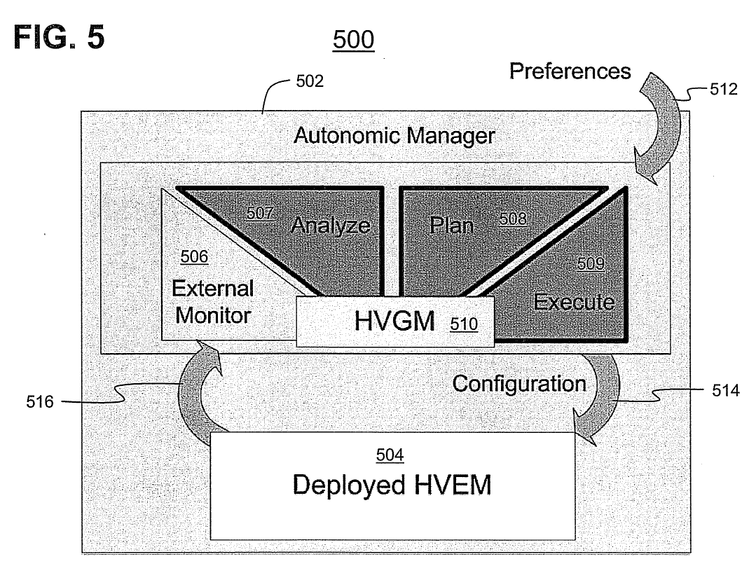

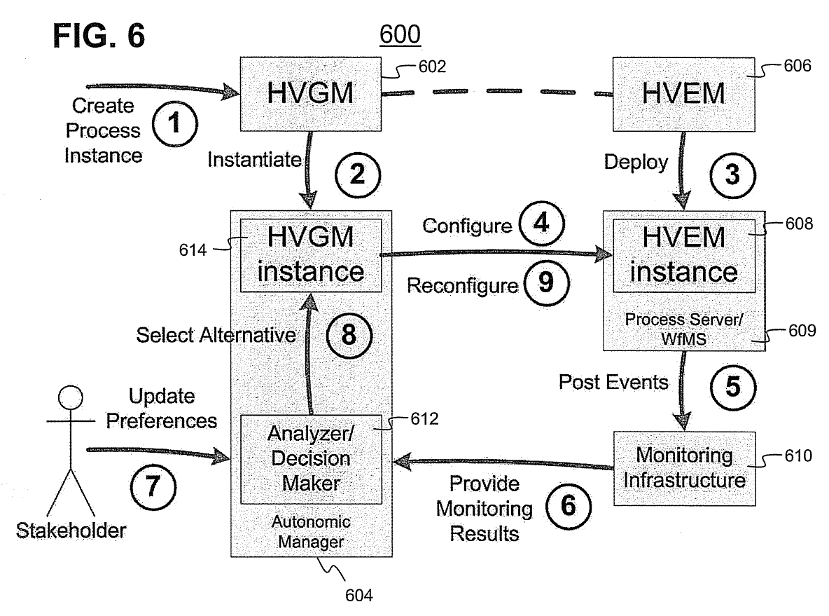

Referring to FIGS. 5 and 6, the runtime adaptations of business processes are illustrated using the models herein. At runtime, the deployed high-variability executable business processes can be adapted based on two inputs, namely, the updated stakeholder preferences and the BP monitoring results. A feature of this approach is that business processes are specified, analyzed, and configured at an intentional level using high-variability goal models. The high-variability executable business processes (HVEMs) can be easily configured based on the analysis done at the goal level by accepting configurations corresponding to the selected HVGM alternative.

FIG. 5 illustrates an autonomic element 500 that can be used in configuring and monitoring the models. In an autonomic computing system as in the present embodiments, an Autonomic Manager (AM) 502 controls its Managed Element (ME) 504 by configuring (514) it, monitoring (516) its performance, deliberating about the needed changes in the ME and executing the changes (using modules 507, 508, and 509 that analyze, plan and execute respectively). Collectively the AM 502 and the ME 504 are called the Autonomic Element 500. The decisions made by an AM 502 are based on the knowledge about the ME 504 and its environment. This knowledge is usually made available to the AM 502 in the form of various models. As shown in FIG. 5, the AM 502 manages the deployed high-variability business processes and their knowledge is provided by the enriched high-variability goal models 510. In one particular embodiment, an external infrastructure (such as the WebSphere Business Monitor) or monitor 506 is used to monitor the deployed processes. The analysis of the monitoring results 516 for a BP as well as the updated stakeholder preferences 512 may result in the change in the process configuration 514. The adaptation of the ME 504 is done by providing it with the new configuration.

With reference to FIG. 6, the steps of the approach of an embodiment at runtime are illustrated with a block diagram of a runtime BP adaptation 600. The method can include (1) the creation of an instance of the BP as a HVGM 602. An autonomic manager (AM) 604 is instantiated (2) based on a particular enriched HVGM 602. A corresponding HVEM instance of an HVEM 606 is deployed (3) to a process server or to a workflow management system (WFMS) 609. The AM 604 then provides (4) the configuration to the HVEM instance 608 corresponding to an initial configuration of the HVGM instance 614. The BP starts executing and is monitored (5) by a business process monitoring infrastructure 610. After low-level data analysis (for example, aggregation), the monitoring results are sent back (6) to the AM 604 for further analysis by an analyzer or decision maker module 612 within the AM 604. At the same time, stakeholders can update (7) their preferences with respect to the running BP instance 614 by changing softgoal priorities or other parameters. The analyzer/decision maker component 612 of the AM 604 deliberates whether or not the currently executing process alternative matches the stakeholder expectations of the process. Firstly, this means that the AM has to determine if the (functional) goals of the process are being achieved (that is, all of the sub-goals of the process delegated either to software components or humans are attained). Secondly, the AM determines if the desired satisfaction levels of the quality attributes are maintained. Based on this analysis, a new process alternative may be selected (8). Based on the newly selected process alternative, a new configuration is communicated (9) to the corresponding HVEM instance 608.

The process illustrated in FIG. 6 and described above allows specification, analysis, configuration, and adaptation of a business process at a high level, in terms of its functional goals and desired quality criteria. Business users or business analysts can specify quality attributes of the process qualitatively, in terms of softgoals like “(Maximize) Customer Satisfaction”, and can make tradeoffs among competing quality attributes. This allows to abstract from concrete metrics and to specify the intentions behind configuration and adaptation of processes. The configuration of the executable BP can be automatically selected based on the preferences. The High-level quality requirements for BPs can be refined or operationalized into measurable KPIs and metrics. This refinement supports traceability from low-level metrics to quality requirements and allows the analysis and representation of monitoring information at high level, in terms of whether the process achieves its functional and quality requirements. Specifically, the method for analyzing executing processes at a high level through the refinements of high-level qualitative preferences into measurable metrics can include two components.

The first component involves the refinement of non-functional requirements specified qualitatively into measurable KPIs/metrics. For business process performance measurement, a high-level user's expectations of processes have to be linked with the data about the deployed BP instances that can be collected with the help of BP monitoring infrastructures (such as the WebSphere Business Monitor). High-level qualitative metrics (softgoals) such as “(Maximize) Performance” are refined into lower-level metrics (KPIs) and down to the metrics directly measurable by the chosen BP monitoring solution. Correlations among various quality dimensions (for example, cost versus performance) can be explicitly specified at various levels of abstraction (for example, it is possible to specify that higher Performance increases the Cost at the level of softgoals or to say that improving the process running time by 10% increases the cost of the process by 15%). The derivation of BP configurations from high-level qualitative preferences over softgoals can make it fairly easy for non-technical users to influence the configuration and adaptation of BPs. It also supports traceability from KPIs/low-level metrics to high-level quality requirements for the BP.

A second component involves analysis and adaptation of BPs at a high level based on the data collected by the BP monitoring infrastructure. During the execution of a deployed BP, the metrics produced by the BP monitoring system (Step 6 in FIG. 6) are sent to the BP Autonomic Manager 604. Then, the softgoal-to-metrics refinement hierarchy is navigated bottom-up from measurable metrics up towards the high-level softgoals where low-level metrics can be correlated and aggregated into higher-level metrics, which, in turn, can be used to produce high-level qualitative evaluations of the relevant softgoals. The latter ones can be used as a very-high-level view of the BP performance. Thus, the performance of a BP alternative can be analyzed at a high level. If the calculated satisfaction levels for softgoals match the target levels, it means the BP alternative is meeting its functional and non-functional business goals.

However, if expectations are not met, the space of alternatives specified in the HVGM and thus implemented by the HVEM can be analyzed in order to find a better alternative (Step 8 in FIG. 6). For example, in the context of the Supply Customer process (as illustrated in FIG. 1), a customer that values Performance (in terms of time) over Customer Cost might provide the appropriate desired alternative. Based on these preferences the variation point “Ship Order” is bound to the alternative “Ship Express”. However, through monitoring instances of “Supply Customer” it can be seen for example that for some reason orders shipped via Express are not arriving any faster than the ones shipped via Standard. This means that while the BP is doing the best it can (within the space of alternatives specified in the Supply Customer HVGM) in terms of performance, the BP can be doing better on Customer Cost by switching to Ship Standard. This new process configuration can attain the functional goals of the process (the products will be supplied to customers) while better meeting the process' non-functional requirements. The new process configuration can then be automatically propagated to the deployed process (Step 9 in FIG. 6). Additionally, process adaptation can be caused by business users changing their preferences with respect to the process (Step 7 in FIG. 6). New preferences can trigger an analysis that is similar to the one above where the space of alternatives will be searched for the one that best matches the new preferences.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A business process (BP) adaptation system, comprising:
a High-Variability enriched Goal Model (HVGM) that captures and refines goals of a business process while modeling alternative options in which goals can be attained, wherein the model captures non-functional or quality attributes used in an evaluation of a performance of the business process and an estimation of how various BP alternatives affect the quality attributes; and
a High-Variability workflow-level/directly Executable Model (HVEM) of the business process, which is semi-automatically generated from the HVGM.

2. The system of claim 1, wherein a best BP alternative can be automatically found based on a prioritization and a desired satisfaction level for the quality attributes of the BP.

3. The system of claim 2, wherein prioritization of quality attributes is done at a high level by a user.

4. The system of claim 1, wherein the HVEM implements a full set or a subset of alternatives specified in a corresponding portion of the HVGM.

5. The system of claim 1, wherein traceability between the HVGM and the HVEM is preserved, enabling configuration of the HVEM based on a currently chosen alternative in a corresponding portion of the HVGM.

6. The system of claim 5, wherein configuration of a BP is done by manipulating quality attributes comprising “Modify Customer Satisfaction” or “Modify Process Cost”.

7. The system of claim 1, wherein the system further comprises a semi-automatic generator of business process metrics based on the quality attributes specified in the HVGM.

8. The system of claim 1, wherein the system further comprises a runtime infrastructure where each deployed BP instance reflects a configuration selected for that instance in a corresponding portion of the HVGM.

9. The system of claim 8, wherein the runtime infrastructure configures the deployed HVEM based on the selected configuration in a corresponding portion of the HVGM.

10. The system of claim 9, wherein the selected configuration is specified in terms of a desired satisfaction levels of quality attributes and their relative priorities.

11. The system of claim 9, wherein the runtime infrastructure further comprises an external monitoring tool for monitoring and analyzing information collected at runtime to enable automated reconfiguration of a deployed HVEM to improve performance in terms of a desired satisfaction level of quality attributes and their relative priorities or to recover from failures by selecting alternative configuration in the set of BP configurations modeled in the HVGM and implemented in HVEM.

12. The system of claim 1, wherein the system is based on goal modeling and analysis for eliciting intentions behind a business process to achieve a desired goal.

13. The system of claim 1, wherein the system explicitly models non-functional or quality concerns represented by softgoal nodes in the HVGM.

14. The system of claim 1, wherein the HVGMs are mapped to HVEMs using Web Services Business Process Specification Language (WS-BPEL) or WebSphere Business Modeler (WBM).

15. A business process (BP) adaptation system, comprising:
a High-Variability enriched Goal Model (HVGM) that captures and refines goals of a business process while modeling alternative options in which goals can be attained, wherein the model captures non-functional or quality attributes used in an evaluation of a performance of the business process and an estimation of how various BP alternatives affect the quality attributes;
a High-Variability workflow-level/directly Executable Model (HVEM) of the business process, which is semi-automatically generated from the HVGM;
wherein the system is based on goal modeling and analysis for eliciting intentions behind a business process to achieve a desired goal system and the HVGM explicitly models non-functional or quality concerns.

16. The system of claim 15, wherein the system further comprises a semi-automatic generator of business process metrics based on the quality attributes specified in the HVGM and a runtime infrastructure where each deployed BP instance reflects a configuration selected for that instance in a corresponding portion of the HVGM.

17. The system of claim 16, wherein the runtime infrastructure further comprises an external monitoring tool for monitoring and analyzing information collected at runtime to enable automated reconfiguration of a deployed HVEM to improve performance in terms of a desired satisfaction level of quality attributes and their relative priorities or to recover from failures by selecting alternative configuration in the set of BP configurations modeled in the HVGM and implemented in HVEM.

18. A computer program embodied in a computer storage medium and operable in a data processing machine for adaptively modeling a business process (BP), comprising instructions executable by the data processing machine that cause the data processing machine to:
provide a High-Variability enriched Goal Model (HVGM) that captures and refines goals of a business process while modeling alternative options in which goals can be attained, wherein the model captures non-functional or quality attributes used in an evaluation of a performance of the business process and an estimation of how various BP alternatives affect the quality attributes;
provide a High-Variability workflow-level/directly Executable Model (HVEM) of the business process, which is semi-automatically generated from the HVGM;
wherein the adaptive modeling is based on goal modeling and analysis for eliciting intentions behind a business process to achieve a desired goal system and the HVGM explicitly models non-functional or quality concerns.

19. The computer program of claim 18, wherein the computer program further comprises instructions for semi-automatically generating business process metrics based on the quality attributes specified in the HVGM and for a runtime infrastructure, wherein each deployed BP instance reflects a configuration selected for that instance in a corresponding portion of the HVGM.

20. The system of claim 16, wherein the runtime infrastructure further comprises an external monitoring tool for monitoring and analyzing information collected at runtime to enable automated reconfiguration of a deployed HVEM to improve performance in terms of a desired satisfaction level of quality attributes and their relative priorities or to recover from failures by selecting alternative configuration in the set of BP configurations modeled in the HVGM and implemented in HVEM.
